(19) United States
(12) Patent Application Publication
(10) Pub. No.: US 2009/0281894 A1
(43) Pub. Date: Nov. 12, 2009

(54) Method and Apparatus for Inferring Topics for Web Pages and Web Ads for Contextual Advertising

(76) Inventor: Adwait Ratnaparkhi, San Jose, CA (US)

Correspondence Address: STATTLER - SUH PC, 60 SOUTH MARKET STREET, SUITE 480, SAN JOSE, CA, 95113, US

(21) Appl. No.: 12/117,329

(22) Filed: May 8, 2008

(51) Int. Cl. G06Q 30/00; G06F 17/30; G06N 5/02

(52) U.S. Cl. 705/14.43; 705/14.45; 707/2; 706/52; 707/5; 707/E17.044; 707/E17.017; 707/E17.002

(57) ABSTRACT

A method and apparatus are provided for inferring topics for web pages and web ads for contextual advertising. In one example, the method includes receiving clicked ads from an ads log database, extracting ad terms from the clicked ads, calculating hidden classes for the ad terms based on an analysis of the ad terms, calculating a probability of each clicked ad appearing in each of the hidden classes, and assigning a topic to each clicked ad based on the probability of each clicked ad appearing in each of the hidden classes.

### FIELD OF THE INVENTION

The present invention relates to web advertising. More particularly, the present invention relates to inferring topics for web pages and web ads for contextual advertising based on click-through data.

### BACKGROUND OF THE INVENTION

Online advertising is a pervasive experience when browsing the world web wide today. One kind of advertising, called sponsored search, aims to place textual ads next to search results that correspond to some consumer query. In contextual advertising or content match, the goal is to place relevant textual ads in content pages, such as news stories or blogs. In the content match scenario, a third party publisher typically reserves some space on their web page for ads, and a server from an ad network (separate from the publisher) supplies ads which are relevant to the page content.

Contextual advertising is a form of online advertising in which textual advertisements are displayed on web pages. Ideally, the textual ads should be relevant to the content or topic of the web page. A good indicator of relevance or “clickability” for an ad with respect to a given page might be the overlap between the words in the page and the words in the ad. However, the choice of words used by the advertiser may differ from the actual words in the content page, even if the text of ad is relevant to the topic of the content page.

Unfortunately, contextual advertising systems which rely purely on word overlap metrics therefore may not retrieve all of the relevant ads for a given content page. Some systems use manually built, as opposed to automatically built, semantic categories to annotate pages and ads with topics. The usual method for determining the relevance of an ad towards page content is a TF-IDF (term frequency—inverse document frequency) score that measures the word overlap between the page content and the ad content. This is an effective technique when the expected word overlap is high, but cannot help if the vocabulary used in the page is expected to be different than the vocabulary used in the ad.

### SUMMARY OF THE INVENTION

What is needed is an improved method having features for addressing the problems mentioned above and new features not yet discussed. Broadly speaking, the present invention fills these needs by providing a method and apparatus for inferring topics for web pages and web ads for contextual advertising. It should be appreciated that the present invention can be implemented in numerous ways, including as a method, a process, an apparatus, a system or a device. Inventive embodiments of the present invention are summarized below.

In one embodiment, an offline method is provided for inferring topics for web pages and web ads for contextual advertising. The offline method comprises receiving clicked ads from an ads log database, extracting ad terms from the clicked ads, calculating hidden classes for the ad terms based on an analysis of the ad terms, calculating a probability of each clicked ad appearing in each of the hidden classes, and assigning a topic to each clicked ad based on the probability of each clicked ad appearing in each of the hidden classes.

In another embodiment, a runtime method is provided for inferring topics for web pages and web ads for contextual advertising. The runtime method comprises receiving a page and an ad request for that page from an ad server, extracting page terms from the page, calculating hidden classes for the page terms based on an analysis of the page terms, calculating a probability of the page appearing in each of the hidden classes, and assigning a topic to the page based on the probability of the page appearing in each of the hidden classes.

In still another embodiment, an offline apparatus if provided for inferring topics for web pages and web ads for contextual advertising. The offline apparatus is configured to receive clicked ads from an ads log database. The offline apparatus comprises an ad feature extractor device configured to extract ad terms from the clicked ads, and to calculate hidden classes for the ad terms based on an analysis of the ad terms; and an ad indexing device configured to calculate a probability of each clicked ad appearing in each of the hidden classes, and to assign a topic to each clicked ad based on the probability of each clicked ad appearing in each of the hidden classes.

In yet another embodiment, a runtime apparatus is provided for inferring topics for web pages and web ads for contextual advertising. The runtime apparatus is configured to receive a page and an ad request for that page from an ad server. The runtime apparatus comprises a page feature extractor device configured to extract page terms from the page, and to calculate hidden classes for the page terms based on an analysis of the page terms; and a page analysis device configured to calculate a probability of the page appearing in each of the hidden classes, and to assign a topic to the page based on the probability of the page appearing in each of the hidden classes.

In still yet another embodiment, a computer readable medium carrying one or more instructions for inferring topics for web pages and web ads for contextual advertising is provided. The one or more instructions, when executed by one or more processors, cause the one or more processors to perform the steps of receiving clicked ads from an ads log database, extracting ad terms from the clicked ads, calculating hidden classes for the ad terms based on an analysis of the ad terms, calculating a probability of each clicked ad appearing in each of the hidden classes, and assigning a topic to each clicked ad based on the probability of each clicked ad appearing in each of the hidden classes.

The invention encompasses other embodiments configured as set forth above and with other features and alternatives.

### BRIEF DESCRIPTION OF THE DRAWINGS

The present invention will be readily understood by the following detailed description in conjunction with the accompanying drawings. To facilitate this description, like reference numerals designate like structural elements.

FIG. 1 is a block diagram of a system for inferring topics for web pages and web ads for contextual advertising from click-through data, in accordance with an embodiment of the present invention;

FIG. 2 is a schematic diagram of the offline training part of the system of FIG. 1, in accordance with an embodiment of the present invention;

FIG. 3 is a schematic diagram of the runtime part of the system of FIG. 1, in accordance with an embodiment of the present invention;

FIG. 4 is a flowchart of an offline method for the offline part of a system for inferring topics for web pages and web ads, in accordance with an embodiment of the present invention; and

FIG. 5 is a flowchart of a runtime method for the runtime part of a system for inferring topics for web pages and web ads, in accordance with an embodiment of the present invention.

### DETAILED DESCRIPTION OF THE INVENTION

An invention is disclosed for a method and apparatus for inferring topics for web pages and web ads for contextual advertising. Numerous specific details are set forth in order to provide a thorough understanding of the present invention. It will be understood, however, to one skilled in the art, that the present invention may be practiced with other specific details.

Overlap between ad and page based on a more abstract attribute like topic may help the content match problem; a relevant ad may match the topic of the page even if there is no word overlap. The system of the present invention involves a novel probability model, called a HCPA (hidden class page-ad) model, which the system can use to infer topics for whole pages and ads. The system also involves an application in which the system uses topic information to produce a more accurate model for predicting consumer clicks on page-ad pairs. The system trains the HCPA model from page-ad pairs corresponding to consumer clicks. The topics that the system derives from this model are an attempt to capture the semantic relationship between the terms in the page and in the ad on which a consumer 108 has clicked. An overlap in topic between the page and an ad therefore ought to indicate high “clickability” (i.e., relevance) for this ad on this page. For this reason, the topics that the system derives from the HCPA model should make good features for the (separate) click model, which integrates the topics as well as other information sources that the system derives from term-overlap features in order to predict the click probability. The description below does not describe all the possible uses of the click probability, but assumes that an accurate click probability is an important goal of a contextual advertising system.

### General Overview

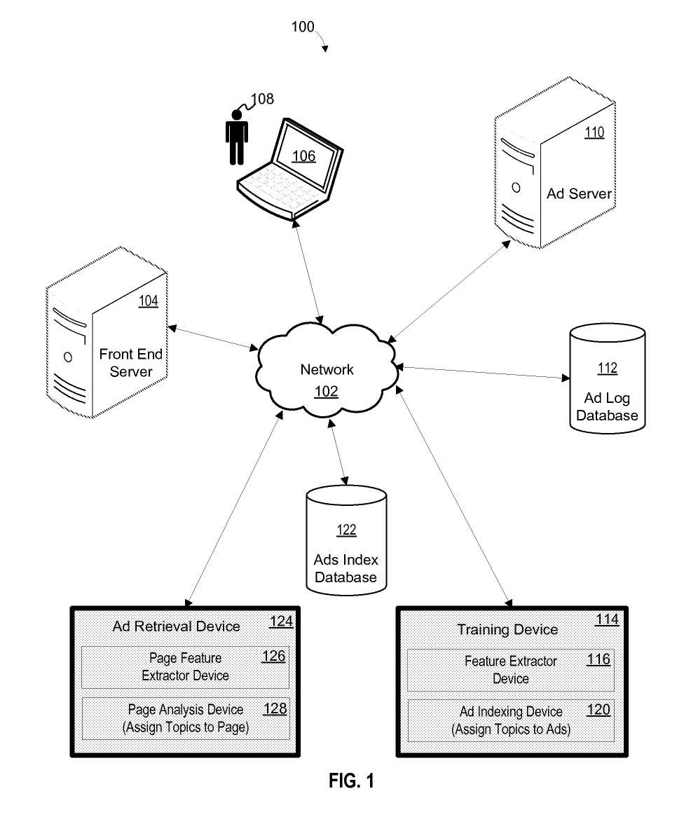

FIG. 1 is a block diagram of a system 100 for inferring topics for web pages and web ads for contextual advertising from click-through data, in accordance with an embodiment of the present invention. A device of the present invention is hardware, software or a combination thereof. A device may sometimes be referred to as an apparatus. Each device is configured to carry out one or more steps of the method of inferring topics for web pages and web ads for contextual advertising from click-through data.

The network 102 couples together a front end server 104, a consumer computer 106, an ad server 110, an ads log database 112, an ad training device 114, an ads index database 122 and an ad retrieval device 124. The network 102 may be any combination of networks, including without limitation the Internet, a local area network, a wide area network, a wireless network and a cellular network. The ad training device 114 includes without limitation an ad feature extractor device 116 and an ad indexing device 120. The ad retrieval device 124 includes without limitation a page feature extractor device 126 and a page analysis device 128.

Alternatively, one apparatus may contain two or more devices of the system 100. For example, one apparatus may contain two or more of the devices that include, for example, the front end server 104, the ad training device 114 and the ad retrieval device 124.

The system 100 is configured to utilize a hidden class page-ad probability (HCPA) model that models the semantic relationships between page terms and ad terms with hidden classes. The ad training device 114 can use these hidden classes to infer topics for whole pages and ads. The ad retrieval device 124 can later use the topics to infer the relevance of an ad to a page, even when there is little or no vocabulary overlap between the ad and the page. The system obtains the hidden class model parameters by applying an EM (expectation maximization) algorithm over a data set of page-ad pairs representing consumer click-throughs. It is important to note that after the ads are in the ads index database 122 with topics; the system 100 can later retrieve these ads based on the computed topic of the page. The discussion below shows example topics that the system 100 obtains from click-through data, and demonstrates that the topic information increases the precision and recall of a second probability model designed to predict clicks for contextual advertising.

### Finding Topics for Pages and Ads

The system 100 is a contextual advertising system of a company like Yahoo!®. The system 100 derives the topic assignments for pages and ads from the ad log database 112. The system includes both an offline training part (i.e., when the system 100 gathers statistics on terms in ads for later use by the ad retrieval device 124) and a runtime part (i.e., when the consumer 108 browses to a page and the ad retrieval device 124 retrieves ads to show on that particular page). The description will sometimes discuss both parts together because the modeling techniques are basically the same for both parts.

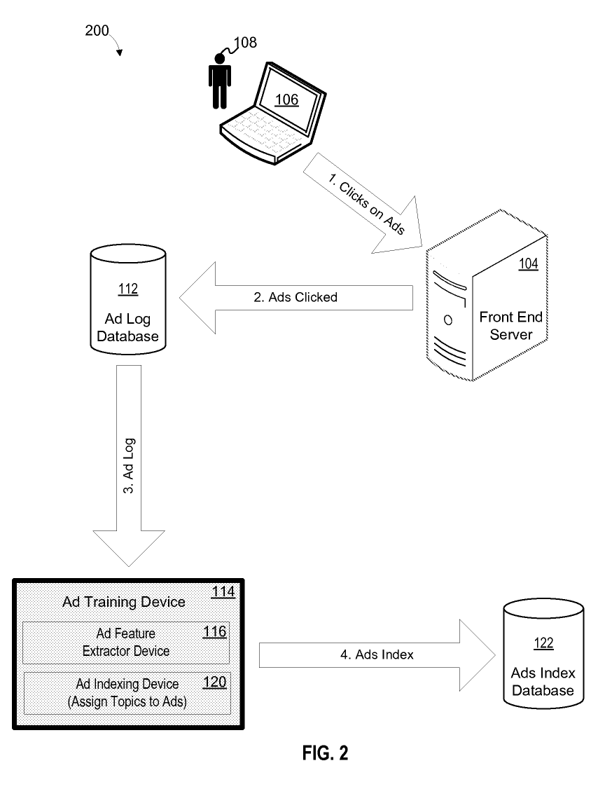

FIG. 2 is a schematic diagram of the offline training part 200 of system 100 of FIG. 1, in accordance with an embodiment of the present invention. For a selected set of web properties, consumers 108 browse to content pages. A company like Yahoo!® is asked to supply the ads. The offline part 200 records the URLs and stores the list of ads. These events are known as impressions. Furthermore, if a consumer 108 clicks on an ad, the offline part 200 also records that event into the ad log database 112. The ad training device 114 receives the ad log. The ad feature extractor device 116 extracts features from the clicked ads and assigns classes to the ad features (i.e., ad terms). The ad indexing device 120 assigns topics to the ads, sorts ads into an ads index and stores the ads index into the ads index database 122.

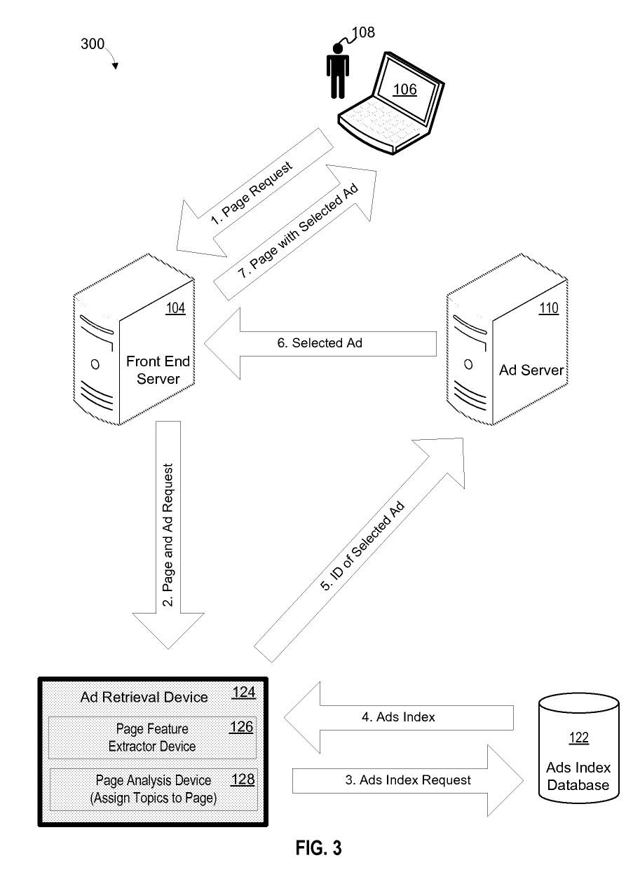

FIG. 3 is a schematic diagram of the runtime part 300 of the system 100 of FIG. 1, in accordance with an embodiment of the present invention. The ad retrieval device 124 assigns topics for pages during the runtime part. A consumer 108 uses the consumer computer 106 to browse to a web page. The consumer computer 106 makes a page request to a front end server 104, which may be operated by a company like Yahoo!®. The ad retrieval device 124 receives the page (or a portion thereof) and an ad request for that page. The page feature extractor device 126 extracts page features. The page analysis device 128 assigns topics to the page. The ad retrieval device 124 obtains the ads index from the ads index database 122, which is was created by the ad training device 114. The ad retrieval device 124 compares the requested page to the ads index, selects the appropriate ad, and sends the identification of selected ad to the ad server 110, which has the full ad. The ad server 110 sends the selected ad to the front end server 104. The front end server 104 then sends the requested page with the appropriately selected ad to the consumer computer. This runtime part 300 typically carries out this cycle in less than one second.

The system 100 obtains the topics from the parameters of a probability model designed to optimize the likelihood of observing a set of page-ad pairs on which consumers 108 have clicked. The probability model uses hidden classes to represent intuition that pages and ads from click events share the same underlying topic. The system 100 can use the parameters of this model to assign topics to entire pages and ads, as will be shown later. In what follows, the system uses “class” to mean structure in the probability model that is relevant to an individual term in a page or ad, and “topic” to mean structure that is assigned to an entire page or ad, even though the system 100 derives one from the other.

### HCPA (Hidden Class Page-Ad) Probability Model

Referring to FIG. 1, the system 100 represents both advertisements and pages as a vector of (possibly non-unique) terms:

ad=(a₁ . . . aₙ).

page=(b₁ . . . bₘ).

These terms could be phrases or individual words extracted from a pre-existing phrase dictionary. Only the first N terms of an ad and the first M terms of a page are used when extracting terms from ads and pages. The probability of an advertisement ad and a page on which the consumer 108 clicked that advertisement can be viewed as the result of the following generative process:

First, generate the class c with probability p(c). This could represent the intended topic that the consumer 108 wants to read.

Second, generate the ad given this class. That is, (a) generate a length n with probability l_{ad}(n|c), where n≦N; generate n ad terms a₁ . . . aₙ, each with probability q_{ad}(aᵢ|c).

Third, generate the page given this class. That is, (a) generate a length m with probability l_{page}(m|c), where m≦M; generate m page terms b₁ . . . bₘ, each with probability q_{page}(bᵢ|c).

The premise of the system 100 is that since the consumer 108 clicked the ad on the page, the ad and page share some semantic or topical relationship, which the system 100 captures in the class c. Also, note that the vocabulary of ad terms can be different than the vocabulary of page terms; the system 100 generates ad terms by different models.

The system 100 collects the set of (page, ad) pairs that represent consumer 108 clicks into a training set T. The page length and page words, as well as the ad length and ad words, of all of the (page, ad) pairs in the training set T are the observed data. The system 100 does not observe the classes and, thus, calls the classes the hidden data.

The probability of seeing an ad and page with a hidden class c is given by

$$\begin{matrix}p ( c , ad , page ) = p ( c ) \cdot p ( ad \vert c ) \cdot p ( page \vert c ) \\ = p ( c ) \cdot {l}_{ad} \text{(} size ( ad \vert c ) {\prod }_{i = 1}^{size ( ad )} {q}_{ad} ( {a}_{i} \vert c ) \cdot \\ {l}_{page} \text{(} size ( page \vert c ) {\prod }_{i = 1}^{size ( page )} {q}_{page} ( {b}_{i} \vert c ) .\end{matrix} \qquad Equation 1$$

where the aᵢ represent words in the ad and the bᵢ represent words in the page, and where size(ad) and size(page) represent the number of words in the ad and page, respectively.

The probability of seeing an ad and page is then the average over the hidden classes. This probability is given as

$$p ( ad , page ) = {\sum }_{c} p ( c , ad , page ) .. \qquad Equation 2$$

The probability of the entire training set T can be written as

$$p ( T ) = {\prod }_{( ad , page ) ∈ T} p ( ad , page ) .. \qquad Equation 3$$

### Parameter Estimation via the Expectation Maximization Algorithm

In the model presented above, the parameters require statistics from the hidden data, and therefore cannot be estimated directly from the observed data. The EM (expectation maximization) algorithm is a parameter estimation procedure that is commonly used in scenarios with hidden data. Instead of using the observed data, the EM algorithm estimates the parameter values from an expectation of the complete (i.e., hidden+observed) training data. On each iteration, the system 100 computes this expectation with a class probability distribution estimated with the parameter values from the previous iteration.

In the E-step of the nth iteration, the system 100 collects the hidden class probabilities, given by

$$p ( c \vert ad , page , {θ}_{n} ) = \frac{p ( c , ad , page \vert {θ}_{n} )}{{\sum }_{{c}^{′}} p ( {c}^{′} , ad , page \vert {θ}_{n} )} . \qquad Equation 4$$

The notation p( . . . |θₙ) indicates that the system 100 computed the probability with the parameter values known at the nth iteration, or θₙ.

In the M-step, the system 100 maximizes the conditional expectation of the complete (i.e., hidden+observed) data log-likelihood Q, which is given by

$$\begin{matrix}Q ( θ , {θ}_{n} ) = {E}_{C \vert T , {θ}_{n}} [ log {\prod }_{( ad , page ) ∈ T} p ( c , ad , page \vert θ ) ] \\ = {E}_{C \vert T , {θ}_{n}} [ {\sum }_{( ad , page ) ∈ T} log p ( c , ad , page \vert θ ) ] \\ = {\sum }_{( ad , page ) ∈ T} {E}_{C \vert ad , page , {θ}_{n}} [ log p ( c , ad , page \vert θ ) ] \\ = {\sum }_{( ad , page ) ∈ T} {\sum }_{c} p ( c \vert ad , page , {θ}_{n} ) log p ( c , ad , page \vert θ ) .\end{matrix} \qquad Equation 5$$

where θ represents the parameters that the system 100 seeks to adjust, including p(c), l_{ad}(n|c), l_{page}(m|c), q_{ad}(a|c), and q_{page}(b|c). T is the training data of ad-page pairs, and C represents a possible sequence of classes corresponding to T. In Equation 5, the system 100 further simplifies Q to be a sum of expectations involving only a single class variable c. This expectation uses the class probability distribution computed with the parameter values θₙ in the E-step.

The EM algorithm says that the value of the parameters that maximizes Q is a good guess for the next iteration, given by

$${θ}_{n + 1} = \text{arg} {max}_{θ} Q ( θ \vert {θ}_{n} ) . \qquad Equation 6$$

The EM algorithm guarantees that the training data likelihood Equation 3 is non-decreasing from one iteration to the next. However, the algorithm may not reach the global maximum.

Maximizing Q subject to the constraint that all the probability distribution parameters denoted by θ sum to 1 yields the following solutions:

$$\begin{matrix}p ( c ) = \frac{{\sum }_{( ad , page ) ∈ T} p ( c \vert ad , page , {θ}_{n} )}{{\sum }_{( ad , page ) ∈ T} {\sum }_{{c}^{′}} p ( {c}^{′} \vert ad , page , {θ}_{n} )} . & Equation 7 \\ {l}_{ad} ( m \vert c ) = \frac{{\sum }_{( ad , page ) ∈ T} p ( c \vert ad , page , {θ}_{n} ) δ ( size ( ad ) , m )}{{\sum }_{( ad , page ) ∈ T} p ( c \vert ad , page , {θ}_{n} )} . & Equation 8 \\ {l}_{page} ( m \vert c ) = \frac{{\sum }_{( ad , page ) ∈ T} p ( c \vert ad , page , {θ}_{n} ) δ ( size ( ad ) , m )}{{\sum }_{( ad , page ) ∈ T} p ( c \vert ad , page , {θ}_{n} )} . & Equation 9 \\ {q}_{ad} ( a \vert c ) = \frac{{\sum }_{( ad , page ) ∈ T} p ( c \vert ad , page , {θ}_{n} ) {\sum }_{i = 1}^{size ( ad )} δ ( a , {a}_{i} )}{{\sum }_{( ad , page ) ∈ T} p ( c \vert ad , page , {θ}_{n} ) size ( ad )} . & Equation 10 \\ {q}_{page} ( b \vert c ) = \frac{{\sum }_{( ad , page ) ∈ T} p ( c \vert ad , page , {θ}_{n} ) {\sum }_{i = 1}^{size ( page )} δ ( b , {b}_{i} )}{{\sum }_{( ad , page ) ∈ T} p ( c \vert ad , page , {θ}_{n} ) size ( page )} . & Equation 11\end{matrix}$$

Here, δ(x,y)=1 if x=y, and 0 otherwise. The solutions to these parameters will comprise the parameter bundle for the next iteration, or θₙ₊₁.

### Example on a Synthetic Data Set

Table 1 lists page-ad pairs of a simple and synthetic example data set, in which consumers 108 who read pages about flavors (e.g., “chocolate”) click on ads about flavors, and consumers 108 who read pages about sports (e.g., “tennis”) click on ads about sports. This data set is not meant to imply that real click-through data is equally simple. The data set is only intended to illustrate the probability model.

TABLE 1
Fictitious click-through data. Each line is one page-ad click.

| Ad text | Page text |
|---|---|
| vanilla | chocolate mint |
| vanilla | strawberry banana |
| football | golf shoes |
| soccer | tennis shoes |

Table 2 below shows the initial model parameters, which are in this case set randomly.

TABLE 2
Initial (random) values for parameters.

| Ad words | p_{ad}(w\|c1) | p_{ad}(w\|c2) |
|---|---|---|
| vanilla | 0.237903 | 0.372296 |
| soccer | 0.606622 | 0.25471 |
| football | 0.155475 | 0.372994 |
| Page words | p_{page}(w\|c1) | p_{page}(w\|c2) |
| golf | 0.0760773 | 0.0760773 |
| banana | 0.107472 | 0.107472 |
| strawberry | 0.246782 | 0.246782 |
| tennis | 0.0187311 | 0.0187311 |
| shoes | 0.216895 | 0.216895 |
| mint | 0.0946441 | 0.0946441 |
| chocolate | 0.239399 | 0.239399 |

Table 3 below shows the model parameters after 20 iterations of the EM algorithm. It is clear from Table 3 that class c1 will generate words in the pages and ads that represent the sports topic, while class c2 will generate words in the flavors topic.

TABLE 3
Parameter values after 20 iterations of EM algorithm.
Class c1 generates terms about sports, while c2 generates
terms about flavors.

| | p_{ad}(w\|c1) | p_{ad}(w\|c2) |
|---|---|---|
| Ad words | | |
| vanilla | 0 | 1 |
| soccer | 0.5 | 0 |
| football | 0.5 | 0 |
| Page words | | |
| golf | 0.25 | 0 |
| banana | 0 | 0.25 |
| strawberry | 0 | 0.25 |
| tennis | 0.25 | 0 |
| shoes | 0.5 | 0 |
| mint | 0 | 0.25 |
| chocolate | 0 | 0.25 |

The following observations are reasons this technique should help the vocabulary mis-match issue in the content match scenario:

First, words in pages that never occurred together are put in the same class by occurring with common word in ad. For example, the system 100 generates the words “chocolate” and “strawberry” by the same class, even though they never occurred together in a page. The words occurred with a common word “vanilla”.

Second, words in ads that never occurred together are put in the same class by occurring with common word in page. For example, the system 100 generates the words “soccer” and “football” by the same class, even though they never occurred together in an ad. The words occurred with a common word “shoes”.

Consequently, one can draw associations between page words and ad words that have never occurred together in a click. For example, the parameters can associate “football” in the ad with “tennis” in the page, since they are both generated by class c1.

### Using the Hidden Classes to Assign Topics

The system 100 can use the same parameters from Equation 3 to define the probability of seeing a class c together with a page. This probability is given by

$$p ( c , page ) = p ( c ) {l}_{page} \text{(} size ( page \vert c ) {\prod }_{i = 1}^{size ( page )} {q}_{page} ( {b}_{i} \vert c ) , . \qquad Equation 12$$

which represents a process in which the system 100 generates the class c, and the words of the page (not the ad). The probability of a class c given a page would then be

$$p ( c \vert page ) = \frac{p ( c , page )}{{\sum }_{{c}^{′}} p ( {c}^{′} , page )} . \qquad Equation 13$$

The same reasoning can be used to generate p(c|ad), or the probability of a class c given an ad. The rest of the description denotes a class that the system 100 has assigned to a page or ad in this way as a topic. A topic is a class that has been assigned to a page or ad.

### Application: Click Modeling

One motivation for creating the topics is to see if they can help another modeling effort in which the system 100 estimates accurately Pr(click|page, ad), which is the probability that a reader will click on the advertisement given features of some page and advertisement ad. One purpose for obtaining such probability would be to estimate the value of an ad for an ad campaign.

The click model is a log-linear model estimated in the maximum entropy framework, given by

$$p ( click \vert page , ad ) = \frac{{\prod }_{j = 1}^{k} {α}_{j}^{{f}_{j} ( page , ad , click )}}{{\sum }_{{click}^{′} ∈ 0 , 1} {\prod }_{j = 1}^{k} {α}_{j}^{{f}_{j} ( page , ad , {click}^{′} )}} . \qquad Equation 14$$

where click is either 1 or 0, denoting a click or non-click, respectively, fⱼ are binary-valued features of the model, and αⱼ>0 are their corresponding parameters. Note that the click model is a separate modeling effort from the page-ad model described above in section “Hidden Class Page-Ad Probability Model”.

The system 100 trains the click model from data where each example has the form (click, page, ad). The system 100 draws the training examples from two kinds of impressions, or consumer page-views:

The first kind is impressions with clicks. If a consumer 108 has clicked on an ad shown on a page, that (page, ad) pair serves as an example with click=1. The system 100 uses the remainder of the ads on the page to create examples for click=0. It is well-known that ads that are displayed higher in an ordered list are often clicked more simply because of their position in the list. To compensate for this bias, the system 100 weighs the examples from clicked impressions by their position, so that an ad at position i has a weight of i. This weighting represents the observed distribution of clicks with respect to position.

The second kind is impressions with no clicks. The system 100 uses all the ads on a page with no clicks as examples for click=0. Each impression is sampled from the space of non-clicked impressions at a rate of 1/N. The system 100 weighs examples drawn from these impressions by N to compensate for the sampling rate. In practice, preferably N=1,000.

### Click Modeling: Baseline Feature Set

The baseline feature set exploits the idea that the page and ad are comprised of different sections, and that term overlap between different sections may have different significance, with respect to clickability. The page and ad sections considered here are, for example, the following:

Page sections
title
meta-description
meta-keyword
body
outgoing link text
header text

Ad sections
title
bidded phrase
   Furthermore, the system 100 uses the notion of DF bin to cluster words together based only on their document frequency. Currently, the DF bin of a word with document frequency df is log₁₀(df).

The features in the baseline set of the click probability model all have the form of

$${f}_{x , y , z} ( click , page , ad ) = \{ \begin{matrix}1 & \begin{matrix}if click = 1 , and there is a \\ matching term in section x of \\ page and section y of ad , \\ and that term is in DF bin z .\end{matrix} \\ 0 & otherwise .\end{matrix} \} . \qquad Equation 15$$

Features of this form will learn how a match of a term in a page section x, ad section y, and DF bin z will contribute towards the probability of a click on that ad. Note that these features are not lexicalized; they only record the presence of a match in a particular combination of page and ad section, and not the actual term that matched. The same feature can trigger multiple times on one training instance. Unigrams and phrases have separate features; there is one set of features for every combination of page section and offer section for word matches and another analogous set for phrase matches.

In addition, the system 100 uses 2 default features which trigger for click=0 and click=1, respectively. These features effectively learn the prior probability of clicking on any ad, regardless of the content of the page or ad.

Click Modeling: Features Derived from HCPA Model

The system 100 can use the topics derived from the HCPA model, described above in the section “Using the Hidden Classes to Assign Topics”, as features in the click probability model. Let top(ad, N) denote the sorted list of the top N topics for ad, sorted by p(c|ad), and let top(page, N) denote the sorted list of the top N topics for page, sorted by p(c|page). Define a new feature type that is active when a certain topic c is in the top N list of the page and ad:

$${f}_{c} ( click , page , ad ) = \{ \begin{matrix}1 & \begin{matrix}if click = 1 , \\ c ∈ top ( page , N ) , \\ c ∈ top ( page , N ) , and \\ p ( c \vert page ) \cdot p ( c \vert ad ) > T\end{matrix} \\ 0 & otherwise\end{matrix} \} . \qquad Equation 16$$

The intent of this feature type is to capture the contribution of a topic match in the top N list of a page and ad towards the probability of the consumer 108 clicking on the ad. It is possible to have a topic match even if the terms in the ad are different than the terms in page. The feature is active only if the product of the scores of the cluster on the ad and page exceed some threshold T, which the system 100 uses as confidence measure in the cluster assignment. In practice, preferably we use N=5 and T=0.0001.

### Method Outline

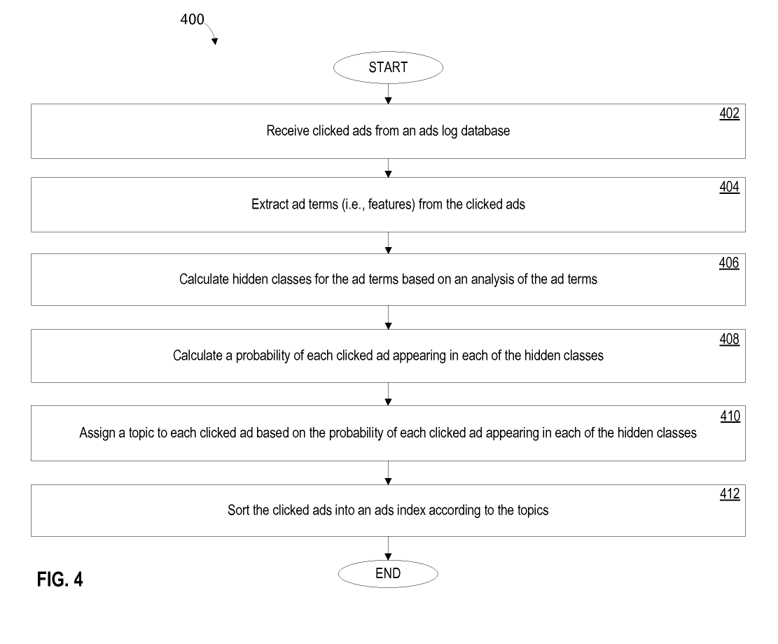

FIG. 4 is a flowchart of an offline method 400 for the offline part of a system for inferring topics for web pages and web ads, in accordance with an embodiment of the present invention. The method starts in step 402 where the system receives clicked ads from an ads log database. The ad training device 114 of FIG. 2 may be configured to carry out this step 402. The offline method 400 then moves to step 404 where the system extracts ad terms (i.e., features) from the clicked ads. The ad feature extractor device 116 of FIG. 2 may be configured to carry out this step 404. Next, in step 406, the system calculates hidden classes for the ad terms based on an analysis of the ad terms. The ad feature extractor device 116 of FIG. 2 may be configured to carry out this step 406. The offline method 400 then proceeds to step 408 where the system calculates a probability of each clicked ad appearing in each of the hidden classes. The ad indexing device 120 of FIG. 2 may be configured to carry out this step 408. Next, in step 410, the system assigns a topic to each clicked ad based on the probability of each clicked ad appearing in each of the hidden classes. The ad indexing device 120 of FIG. 2 may be configured to carry out this step 410. The offline method 400 then moves to step 412 where the system sorts the clicked ads into an ads index according to the topics. The ad indexing device 120 of FIG. 2 may be configured to carry out this step 412. The offline method 400 is then at an end.

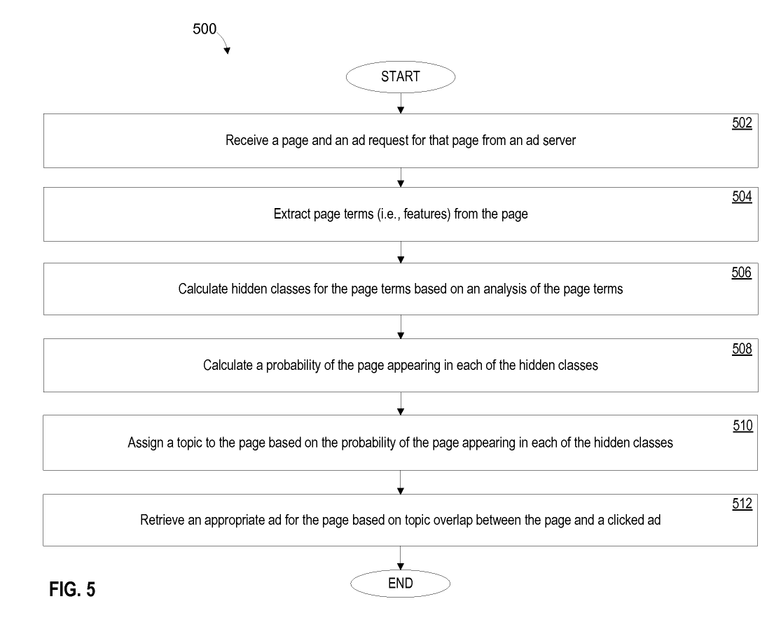

FIG. 5 is a flowchart of a runtime method 500 for the runtime part of a system for inferring topics for web pages and web ads, in accordance with an embodiment of the present invention. The runtime method 500 starts in step 502 where the system receives a page and an ad request for that page from an ad server. The ad retrieval device 124 of FIG. 3 may be configured to carry out this step 502. The runtime method 500 then moves to step 504 where the system extracts page terms (i.e., features) from the page. The page feature extractor device 126 of FIG. 3 may be configured to carry out this step 504. Next, in step 506, the system calculates hidden classes for the page based on analysis of the page terms. The page feature extractor device 126 of FIG. 3 may be configured to carry out this step 506. The runtime method 500 then proceeds to step 508 where the system calculates a probability of the page appearing in each of the hidden classes. The page analysis device 128 of FIG. 3 may be configured to carry out this step 508. Next, in step 510, the system assigns a topic to the page based on the probability of the page appearing in each of the hidden classes. The page analysis device 128 of FIG. 3 may be configured to carry out this step 510. The runtime method 500 then moves to step 512 where the system retrieves an appropriate ad for the page based on topic overlap. The ad retrieval device 124 of FIG. 3 may be configured to carry out this step 512. The runtime method 500 is then at an end.

### Computer Readable Medium Implementation

Portions of the present invention may be conveniently implemented using a conventional general purpose or a specialized digital computer or microprocessor programmed according to the teachings of the present disclosure, as will be apparent to those skilled in the computer art.

Appropriate software coding can readily be prepared by skilled programmers based on the teachings of the present disclosure, as will be apparent to those skilled in the software art. The invention may also be implemented by the preparation of application-specific integrated circuits or by interconnecting an appropriate network of conventional component circuits, as will be readily apparent to those skilled in the art.

The present invention includes a computer program product which is a storage medium (media) having instructions stored thereon/in which can be used to control, or cause, a computer to perform any of the processes of the present invention. The storage medium can include, but is not limited to, any type of disk including floppy disks, mini disks (MD's), optical disks, DVDs, CD-ROMs, micro-drives, and magneto-optical disks, ROMs, RAMs, EPROMs, EEPROMs, DRAMs, VRAMs, flash memory devices (including flash cards), magnetic or optical cards, nanosystems (including molecular memory ICs), RAID devices, remote data storage/archive/warehousing, or any type of media or device suitable for storing instructions and/or data.

Stored on any one of the computer readable medium (media), the present invention includes software for controlling both the hardware of the general purpose/specialized computer or microprocessor, and for enabling the computer or microprocessor to interact with a human consumer or other mechanism utilizing the results of the present invention. Such software may include, but is not limited to, device drivers, operating systems, and consumer applications. Ultimately, such computer readable media further includes software for performing the present invention, as described above.

Included in the programming (software) of the general/specialized computer or microprocessor are software modules for implementing the teachings of the present invention, including without limitation receiving clicked ads from an ads log database, extracting ad terms from the clicked ads, calculating hidden classes for the ad terms based on an analysis of the ad terms, calculating a probability of each clicked ad appearing in each of the hidden classes, and assigning a topic to each clicked ad based on the probability of each clicked ad appearing in each of the hidden classes, according to processes of the present invention.

### Advantages

The topics have been shown to increase the precision of predicting click-throughs on page-ad pairs. In offline training, the system automatically infers the topics from click-through data. The algorithm is therefore independent of any one domain, or any one language. Prior work has used manually built semantic categories to annotate pages and ads with topics. In contrast, the system of the present invention builds the topics without human assistance.

This system presents a novel probability model for page-ad pairs trained from click-through data, using hidden classes to model the semantic relationships between terms. The system uses the parameters of this model to assign topics to whole pages and ads. The system uses topic overlap (as opposed to merely word overlap) between a page and ad to imply that the ad is likely to be clicked. These topics, when used as features in a click probability model, show an improvement in precision and recall, when compared to a model that uses only term overlap features.

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense.

What is claimed is:

1. An offline method of inferring topics for web pages and web ads for contextual advertising, the offline method comprising:
receiving clicked ads from an ads log database;
extracting ad terms from the clicked ads;
calculating hidden classes for the ad terms based on an analysis of the ad terms;
calculating a probability of each clicked ad appearing in each of the hidden classes; and
assigning a topic to each clicked ad based on the probability of each clicked ad appearing in each of the hidden classes.

2. The offline method of claim 1, further comprising sorting the clicked ads into an ads index according to the topics.

3. The offline method of claim 1, wherein the analysis of the ad terms includes a probability model designed to optimize the likelihood of observing a set of page-ad pairs on which consumers have clicked.

4. The offline method of claim 1, wherein each hidden class represents an intuition that pages and ads from click events share a same underlying topic.

5. The offline method of claim 3, wherein each hidden class represents a structure in the probability model that is relevant to an individual term in at least one of a page and an ad, and wherein each topic represents a structure that is assigned to at least one of an entire page or an entire ad.

6. A runtime method of inferring topics for web pages and web ads for contextual advertising, the runtime method comprising:
receiving a page and an ad request for that page from an ad server;
extracting page terms from the page;
calculating hidden classes for the page terms based on an analysis of the page terms;
calculating a probability of the page appearing in each of the hidden classes; and
assigning a topic to the page based on the probability of the page appearing in each of the hidden classes.

7. The runtime method of claim 6, the runtime method further comprising retrieving an appropriate ad for the page based on topic overlap between the page and a clicked ad.

8. The runtime method of claim 6, wherein the analysis of the page terms includes a probability model designed to optimize the likelihood of observing a set of page-ad pairs on which consumers have clicked.

9. The runtime method of claim 8, wherein each hidden class represents an intuition that pages and ads from click events share a same underlying topic.

10. The runtime method of claim 8, wherein each hidden class represents a structure in the probability model that is relevant to an individual term in at least one of a page and an ad, and wherein each topic represents a structure that is assigned to at least one of an entire page or an entire ad.

11. An offline apparatus for inferring topics for web pages and web ads for contextual advertising, the offline apparatus configured to receive clicked ads from an ads log database, the offline apparatus comprising:
an ad feature extractor device configured to extract ad terms from the clicked ads, and to calculate hidden classes for the ad terms based on an analysis of the ad terms; and
an ad indexing device configured to calculate a probability of each clicked ad appearing in each of the hidden classes, and to assign a topic to each clicked ad based on the probability of each clicked ad appearing in each of the hidden classes.

12. The offline apparatus of claim 11, wherein the ads indexing device is and ad training device configured to sort the clicked ads into an ads index according to the topics.

13. The offline apparatus of claim 11, wherein the analysis of the ad terms includes a probability model designed to optimize the likelihood of observing a set of page-ad pairs on which consumers have clicked.

14. The offline apparatus of claim 11, wherein each hidden class represents an intuition that pages and ads from click events share a same underlying topic.

15. The offline apparatus of claim 13, wherein each hidden class represents a structure in the probability model that is relevant to an individual term in at least one of a page and an ad, and wherein each topic represents a structure that is assigned to at least one of an entire page or an entire ad.

16. A runtime apparatus for inferring topics for web pages and web ads for contextual advertising, the runtime apparatus configured to receive a page and an ad request for that page from an ad server, the runtime apparatus comprising:
a page feature extractor device configured to extract page terms from the page, and to calculate hidden classes for the page terms based on an analysis of the page terms; and
a page analysis device configured to calculate a probability of the page appearing in each of the hidden classes, and to assign a topic to the page based on the probability of the page appearing in each of the hidden classes.

17. The runtime apparatus of claim 16, wherein the runtime apparatus is an ad retrieval device configured to retrieve an appropriate ad for the page based on topic overlap between the page and a clicked ad.

18. The runtime apparatus of claim 16, wherein the analysis of the page terms includes a probability model designed to optimize the likelihood of observing a set of page-ad pairs on which consumers have clicked.

19. The runtime apparatus of claim 16, wherein each hidden class represents an intuition that pages and ads from click events share a same underlying topic.

20. The runtime apparatus of claim 18, wherein each hidden class represents a structure in the probability model that is relevant to an individual term in at least one of a page and an ad, and wherein each topic represents a structure that is assigned to at least one of an entire page and an entire ad.

21. A computer readable medium carrying one or more instructions for inferring topics for web pages and web ads for contextual advertising, wherein the one or more instructions, when executed by one or more processors, cause the one or more processors to perform the steps of:
receiving clicked ads from an ads log database;
extracting ad terms from the clicked ads;
calculating hidden classes for the ad terms based on an analysis of the ad terms;
calculating a probability of each clicked appearing in each of the hidden classes; and
assigning a topic to each clicked ad based on the probability of each clicked ad appearing in each of the hidden classes.
